(19) United States
(12) Patent Application Publication
(10) Pub. No.: US 2003/0223230 A1
(43) Pub. Date: Dec. 4, 2003

(54) Compact fluorescent lamp

(76) Inventor: Qingsong Li, Irving, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/212,939

(22) Filed: Aug. 6, 2002

Related U.S. Application Data
(63) Continuation-in-part of application No. 29/161,695, filed on May 31, 2002.

(51) Int. Cl. F21V 7/10

(52) U.S. Cl. 362/216; 362/260

(57) ABSTRACT

In accordance with an embodiment of the present invention, a compact fluorescent lamp comprises a spiral compact fluorescent tube comprising a plurality of loops, at least one of the plurality of loops having a different cross-sectional width than a cross-sectional width of at least another one of the plurality of loops.

### BACKGROUND OF THE INVENTION

Many residential lighting products and light fixtures are configured around incandescent bulbs. Homeowners enjoy the warm light, low initial cost, and compact size of incandescent bulbs.

A different type of lighting product, known as a fluorescent lamp, is also available. A fluorescent lamp comprises a ballast and a glass tube with two electrodes, one at each end. The ballast is used to regulate electric current into the lamp. When switched on, electric current passes through the ballast. Electric current then passes in an arc between the electrodes through an inert gas in the glass tube. Heat from the arc vaporizes tiny drops of mercury in the glass tube, making them produce ultraviolet light, which in turn causes a phosphor coating on the inside surface of the glass tube to glow brightly and radiate in all directions. The most common configuration of a fluorescent lamp glass tube is a straight line. When compared with incandescent bulbs, fluorescent lamps use less electricity and typically last longer. These and other qualities make fluorescent lamps desirable substitutes for incandescent bulbs.

The general term “compact fluorescent lamp” (CFL) applies to smaller-sized fluorescent lamps, most of which have built-in ballasts and a threaded base that may be installed in a standard incandescent bulb socket. Although the underlying physics is the same, a CFL represents quite a departure from a standard fluorescent lamp. First, the color of light produced by a CFL is nearly identical to that of an incandescent bulb. Also, the threaded bases enable them to fit most standard incandescent bulb sockets. A spiral shaped CFL with a cylindrical profile, such as shown in FIGS. 1A and 1B, is currently the most popular CFL. The drawbacks associated with fluorescent lighting products, e.g., cold-looking light, blinking, awkward sizes and high-pitched noise, have largely disappeared in modern CFLs.

### SUMMARY OF THE INVENTION

In accordance with an embodiment of the present invention, a compact fluorescent lamp comprises a spiral compact fluorescent tube comprising a plurality of loops, at least one of the plurality of loops having a different cross-sectional width than a cross-sectional width of at least another one of the plurality of loops.

In accordance with another embodiment of the present invention, a compact fluorescent lamp comprises a spiral compact fluorescent tube comprising of a plurality of loops of non-uniform cross-sectional width.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention, the objects and advantages thereof, reference is now made to the following descriptions taken in connection with the accompanying drawings in which:

FIG. 1A is a front elevational view of a conventional compact fluorescent lamp and FIG. 1B is a plan view showing a distal end of the compact fluorescent lamp of FIG. 1A;

FIG. 2A is a front elevational view of a conventional lamp reflector and FIG. 2B is a plan view showing a distal end of the lamp reflector of FIG. 2A;

FIG. 3 is a front elevational view of a compact fluorescent lamp in accordance with an embodiment of the present invention;

FIG. 4 illustrates light radiation pattern when the compact fluorescent lamp of FIG. 1A is combined with the lamp reflector of FIG. 2A shown in phantom;

FIG. 5A illustrates light radiation pattern of the compact fluorescent lamp of FIG. 3 when combined with a lamp reflector in accordance with an embodiment of the present invention;

FIG. 5B is a plan view showing a distal end of the compact fluorescent lamp reflector of FIG. 5A; and

FIG. 6 is a front elevational view of a compact fluorescent lamp in accordance with an alternative embodiment of the present invention.

### DETAILED DESCRIPTION OF THE DRAWINGS

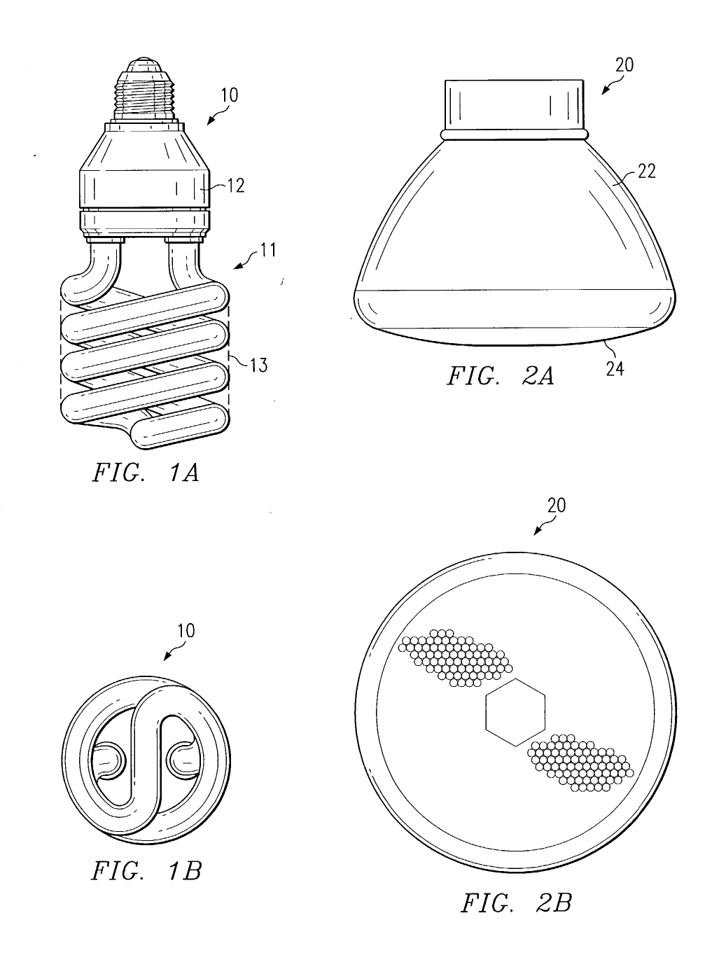

The preferred embodiment of the present invention and its advantages are best understood by referring to FIGS. 1 through 6 of the drawings.

FIG. 1A is a front elevational view of a conventional compact fluorescent lamp 10 and FIG. 1B is a plan view showing a distal end of compact fluorescent lamp 10. Compact fluorescent lamp 10 comprises a compact fluorescent tube 11 and a ballast 12. FIG. 2A is a front elevational view of a conventional lamp reflector 20 and FIG. 2B is a plan view showing a distal end of lamp reflector 20. Lamp reflector 20 comprises a housing 22 and a cover 24.

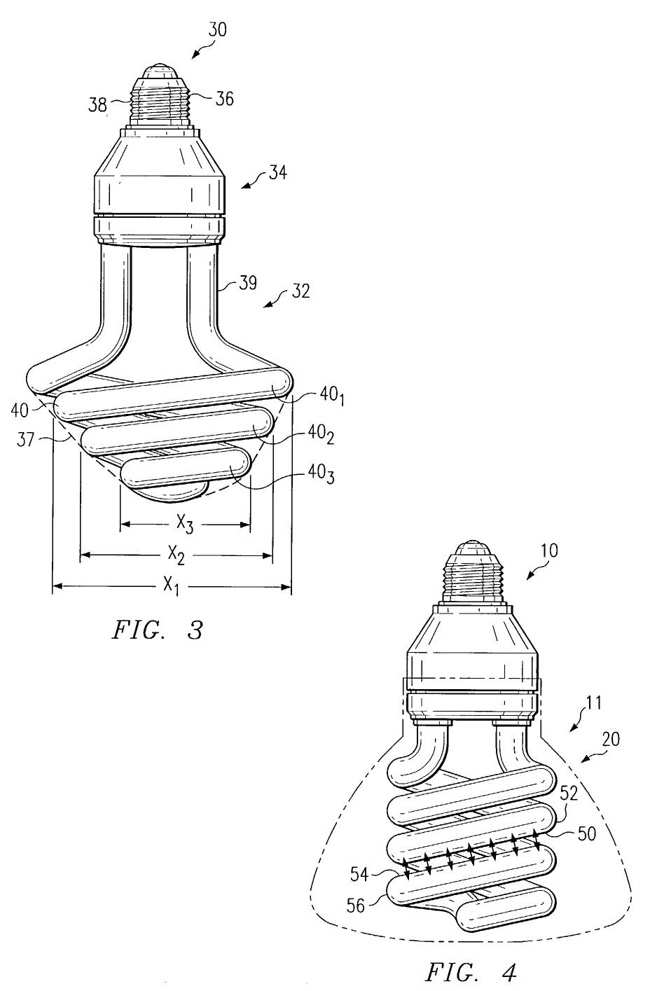

FIG. 3 is a front elevational view of a compact fluorescent lamp 30 in accordance with an embodiment of the present invention. Lamp 30 comprises a compact fluorescent tube 32 coupled to a ballast 34. Ballast 34 may be any ballast now known or later developed. Preferably, ballast 34 comprises a base 36. Preferably, base 36 is adapted for coupling with a conventional electrical light socket (not shown), for example an electrical socket used for incandescent bulbs. In the illustrated embodiment, base 36 has a plurality of threads 38 on the outer surface thereof for coupling lamp 30 with a conventional electrical socket for incandescent bulbs.

Tube 32 comprises a proximal portion 39 and a distal portion 40. Preferably, proximal portion 39 couples with ballast 34. Distal portion 40 of tube 32 preferably has a circular spiral configuration and comprises a plurality of“loops”. Depending on the desired shape or profile, tube 32 may have a more angular spiral configuration, for example triangular, square, rectangular, and/or the like. In the illustrated embodiment, distal portion 40 comprises loops 40₁, 40₂ and 40₃. Preferably, the plurality of loops of tube 32 are of non-uniform cross-sectional width or diameter. The cross-sectional width of loop 40₁, is X₁, the cross-sectional width of loop 40₂ is X₂ and the cross-sectional width of loop 40₃ is X₃. As can be seen from FIG. 3, the cross-sectional width of loops 40₁, 40₂ and 40₃ is such that X₁>X₂>X₃. In other words, the loop closest to ballast 34 has the largest cross-sectional width and the cross-sectional width of the loops gradually decrease such that the loop farthest from ballast 34 has the smallest cross-sectional width. If desired, in an alternative embodiment, the cross-sectional width of the loops of tube 32 may be such that the loop closest to ballast 34 has the smallest cross-sectional width and the cross-sectional width of the loops gradually increase such that the loop farthest from ballast 34 has the largest cross-sectional width.

As illustrated in FIGS. 1A and 1B, each loop of conventional lamp 10 is of the same cross-sectional width. As such, as shown in part by broken lines 13 in FIG. 1A, a profile of tube 11 of fluorescent lamp 10 along its longitudinal axis is substantially cylindrical. On the other hand, as illustrated by broken lines 37 in FIG. 3, a profile of tube 32 of lamp 30 along its longitudinal axis is substantially conical. Even if the length of tube 11 of lamp 10 and the length of tube 32 of lamp 30 are the same, the loops of lamp 30 are designed such that the width of the widest loop in lamp 30 is greater than the width of the loops in conventional lamp 10. As such, light from lamp 30 is spread out over a greater area than the light from lamp 10.

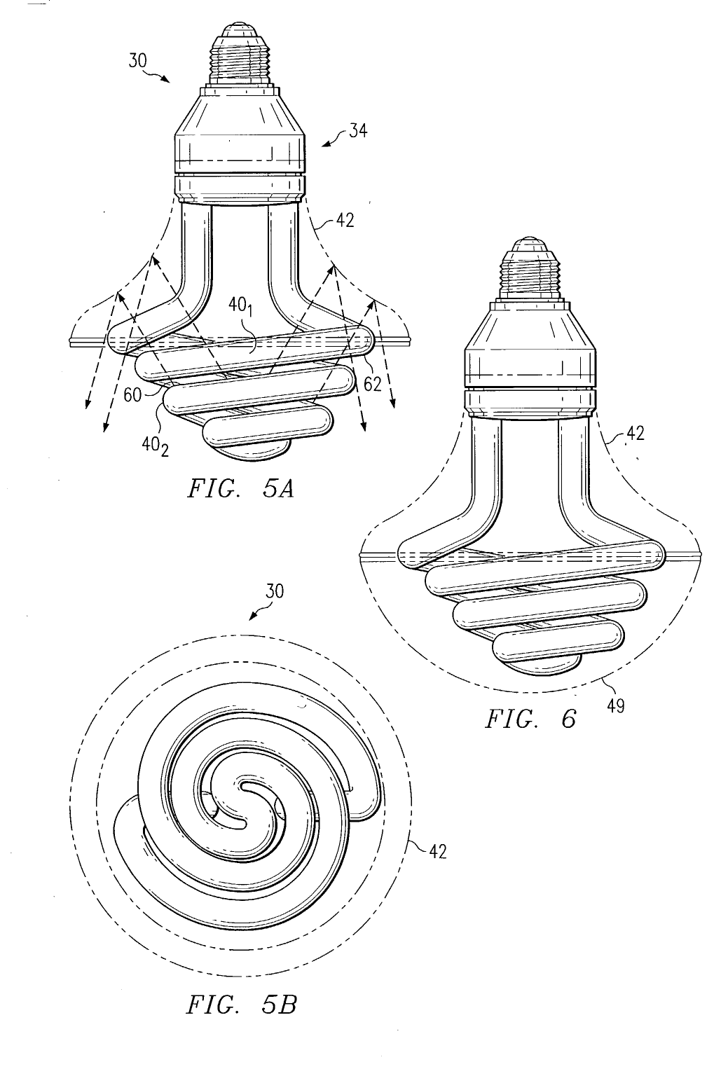

If desired, lamp 30 may comprise a lamp reflector 42 (FIG. 5A). Lamp reflector 42 is preferably coupled to ballast 34 or base 36. Lamp reflector 42 has an inner reflective surface adapted to reflect light from tube 32 to augment light output. When light from tube 32 falls on the inner surface of lamp reflector 42, the light is reflected and directed outwardly away from lamp 30. As illustrated in FIG. 5A, lamp reflector 42 is preferably “funnel-shaped”. The shape of an outer surface of lamp reflector 42 is generally concave with respect to a longitudinal axis of lamp 40 with the cross-sectional width of lamp reflector 42 increasing linearly or non-linearly from an end proximal to ballast 34 towards an end distal from ballast 34. Preferably, lamp reflector 42 is narrowest at the proximal end and widest at the distal end. The illustrated shape of lamp reflector 42 enables a higher light output from lamp 30 than a conventional compact fluorescent lamp with a compact fluorescent tube of substantially identical length.

In the illustrated embodiment of FIG. 5A, lamp reflector 42 does not comprise a cover. A substantially transparent or translucent cover 49 may be coupled to lamp reflector 42 (FIG. 6) to either hide the lamp from view or to reduce the effect of glare from the lamp, if desired. The omission of cover 49 may result in a reduction in the cost of the lamp.

FIG. 4 illustrates light radiation pattern when the compact fluorescent lamp of FIGURE IA is combined with a lamp reflector. In FIG. 4, lamp reflector 20 is shown in phantom. As illustrated in FIG. 4, because the loops of tube 11 are of the same cross-sectional width, a lower surface 50 of a loop 52 obstructs light emitting from an upper surface 54 of a loop 56 immediately below it, and vice versa. This is generally known in the industry as“self-shading”.

On the other hand, in lamp 30, because of the staggering of the cross-sectional widths of the loops, light emitting from each loop does not become blocked or obstructed by a neighboring loop. Therefore, components of lamp 30 do not“self-shade” light emitting from the lamp. FIG. 5A illustrates light radiation pattern of compact fluorescent lamp 30 of FIG. 3 when lamp 30 comprises lamp reflector 42. Because the loops of lamp 30 are of different cross-sectional width, light from an upper surface 60 of loop 40₂ is not obstructed by a lower surface 62 of loop 40₁ and vice versa. Instead, light from upper surface 60 is reflected off the inner surface of lamp reflector 42. Thus, in an exemplary embodiment of the present invention, partly because of the shape of tube 32, self-shading is reduced thereby increasing the light output.

Recesses of various sizes may be provided in ceilings and walls so that the lamps (whether conventional or in accordance with the present invention) may fit into the recesses and be at least partially hidden from view. The widths of these recesses are usually specified as R30 or R40, wherein a recess whose width is specified by R30 is of smaller width than a recess whose width is specified by R40.

It has been empirically determined that the maximum wattage of a conventional compact fluorescent lamp, such as lamp 10, that may fit into a fixture whose width is specified by R30 is 15W, whereas the maximum wattage of a conventional compact fluorescent lamp, such as lamp 10, that may fit into a fixture whose width is specified by R40 is 26W. On the other hand, the maximum wattage of a compact fluorescent lamp of an exemplary embodiment of the present invention, such as lamp 30, that may fit into a fixture whose width is specified by R30 is 20W, whereas the maximum wattage of a compact fluorescent lamp of an exemplary embodiment of the present invention, such as lamp 30, that may fit into a fixture whose width is specified by R40 is 30W.

It has been empirically determined that the light output of a conventional compact fluorescent lamp, such as lamp 10, is 62 lumens/watt, whereas the light output of a compact fluorescent lamp of an exemplary embodiment of the present invention, such as lamp 30, is 67 lumens/watt. A wattage and total light output comparison of a conventional compact fluorescent lamp and a compact fluorescent lamp in accordance with an exemplary embodiment of the present invention is given in Table I.

TABLE I

| | Wattage | | Total Light Output | |
|---|---|---|---|---|
| | (watt) | | (lumen) | |
| | R30 | R40 | R30 | R40 |
| Conventional Compact | 15 | 26 | 15*62 = 930 | 26*62 = 1612 |
| Fluorescent Lamp | | | | |
| Exemplary Compact | 20 | 30 | 20*67 = 1340 | 30*67 = 2010 |
| Fluorescent Lamp | | | | |

The maximum overall length of a lamp includes the length of the ballast and the tube. The maximum overall length of lamp 30 is generally less than the maximum overall length of a conventional compact fluorescent lamp, such as lamp 10.

Table II provides a comparison of the maximum overall length for lamps of different wattage.

TABLE II

| | Conventional Compact | Exemplary Compact |
|---|---|---|
| Wattage | Fluorescent Lamp | Fluorescent Lamp |
| (watt) | (mm) | (mm) |
| 15 | 140 | 126 |
| 18 | 143 | 131 |
| 20 | 146 | 138 |
| 23 | 158 | 142 |
| 26 | 162 | 145 |

As illustrated in Table II, the maximum overall length of exemplary compact fluorescent lamp 30 is less than the maximum overall length of conventional compact fluorescent lamp 10 of comparable wattage. Because the maximum overall length of exemplary compact fluorescent lamp 30 is less than the maximum overall length of conventional compact fluorescent lamp 10, lamp 30 does not protrude out of standard recesses whose width is denoted by R30 or R40. This results in a more pleasing configuration especially desirable and suitable for high-end interior lighting needs.

If desired, the maximum overall length of compact fluorescent lamp 30 may be during design by adjusting the gap between successive loops and/or by adjusting the cross-sectional widths of the loops. For example, if desired, the maximum overall length may be reduced by reducing the gap between successive loops and/or by increasing the cross-sectional widths of the loops.

While the invention has been particularly shown and described by the foregoing detailed description, it will be understood by those skilled in the art that various other changes in form and detail may be made without departing from the spirit and scope of the invention.

What is claimed is:

1. A compact fluorescent lamp, comprising:
a spiral compact fluorescent tube comprising a plurality of loops, at least one of said plurality of loops having a different cross-sectional width than a cross-sectional width of at least another one of said plurality of loops.

2. The compact fluorescent lamp of claim 1, further comprising a ballast coupled to said compact fluorescent tube.

3. The compact fluorescent lamp of claim 1, further comprising:
a ballast coupled to said compact fluorescent tube; and
a lamp reflector coupled to said ballast and operable to reflect light emitted by said compact fluorescent tube.

4. The compact fluorescent lamp of claim 3, wherein a shape of an outer surface of said lamp reflector is generally concave with respect to a longitudinal axis of said compact fluorescent lamp with a cross-sectional width of said lamp reflector increasing non-linearly from an end proximal to said ballast to a distal end.

5. The compact fluorescent lamp of claim 3, wherein an outer surface of said lamp reflector is funnel-shaped with a cross-sectional width of said lamp reflector increasing linearly from an end proximal to said ballast to a distal end.

6. The compact fluorescent lamp of claim 3, wherein said lamp reflector comprises a reflector cover coupled to a distal end of said lamp reflector, said reflector cover operable to reduce glare from said spiral compact fluorescent lamp.

7. The compact fluorescent lamp of claim 1, wherein a profile of said spiral compact fluorescent tube along a longitudinal axis of said compact fluorescent lamp is substantially conical.

8. The compact fluorescent lamp of claim 1, wherein a profile of said spiral compact fluorescent tube along a longitudinal axis of said compact fluorescent lamp is non-cylindrical.

9. The compact fluorescent lamp of claim 2, wherein a loop of said plurality of loops closest to said ballast has a cross-sectional width larger than a cross-sectional width of any other loop of said plurality of loops.

10. The compact fluorescent lamp of claim 2, wherein a loop of said plurality of loops farthest from said ballast has a cross-sectional width smaller than a cross-sectional width of any other loop of said plurality of loops.

11. The compact fluorescent lamp of claim 2, wherein a cross-sectional width of each of said plurality of loops is staggered with the cross-sectional width of a loop closest to said ballast being the largest and the cross-sectional width of a loop farthest from said ballast being the smallest.

12. The compact fluorescent lamp of claim 1, wherein a configuration of each of said plurality of loops is circular.

13. The compact fluorescent lamp of claim 2, wherein a first loop of said plurality of loops has a cross-sectional width of X₁, a second loop of said plurality of loops has a cross-sectional width of X₂, and a third loop of said plurality of loops has a cross-sectional width of X₃, such that X₁>X₂>X₃.

14. The compact fluorescent lamp of claim 2, wherein said plurality of loops comprise three loops of decreasing cross-sectional widths such that a cross-sectional width of a loop closest to said ballast is greater than a cross-sectional width of the other two loops of said three loops.

15. The compact fluorescent lamp of claim 13, wherein said first loop is closer to said ballast than said second and third loops and said second loop is in between said first and third loops.

16. A compact fluorescent lamp, comprising:
a spiral compact fluorescent tube comprising of a plurality of loops of non-uniform cross-sectional width.

17. The compact fluorescent lamp of claim 16, further comprising a ballast coupled to said compact fluorescent tube, wherein said ballast is adapted to couple with an electrical light socket.

18. The compact fluorescent lamp of claim 16, further comprising a ballast coupled to said compact fluorescent tube, wherein a plurality of threads are provided on an outer surface of said ballast to facilitate coupling of said ballast with an electrical light socket.

19. The compact fluorescent lamp of claim 17, further comprising a lamp reflector coupled to said ballast, said lamp reflector operable to reflect light emitted by said compact fluorescent tube.

20. The compact fluorescent lamp of claim 19, wherein an outer surface of said lamp reflector is generally concave with respect to a longitudinal axis of said compact fluorescent lamp with a cross-sectional width of said lamp reflector increasing non-linearly from an end proximal to said ballast to a distal end.

21. The compact fluorescent lamp of claim 19, wherein an outer surface of said lamp reflector is funnel-shaped with a cross-sectional width of said lamp reflector increasing linearly from an end proximal to said ballast to a distal end.

22. The compact fluorescent lamp of claim 19, said lamp reflector being shaped to reflect light emitting from said compact fluorescent tube in a direction outwardly away from said compact fluorescent lamp.

23. The compact fluorescent lamp of claim 17, wherein said plurality of loops comprise three loops of decreasing cross-sectional widths.

24. The compact fluorescent lamp of claim 23, wherein a cross-sectional width of a loop closest to said ballast is greater than a cross-sectional width of the other two loops of said three loops.

25. A compact fluorescent lamp, comprising:
a spiral compact fluorescent tube comprising of a plurality of loops, at least two of said plurality of loops having cross-sectional widths different from any other loop of said plurality of loops;
a ballast coupled to said spiral compact fluorescent tube, said ballast operable to regulate flow of current into said spiral compact fluorescent tube; and
a lamp reflector coupled to said ballast and operable to reflect light emitting from said spiral compact fluorescent tube.

26. The compact fluorescent lamp of claim 25, wherein said compact fluorescent lamp consumes electricity at the rate of thirty watts.

27. The compact fluorescent lamp of claim 25, wherein a light output of said compact fluorescent lamp is sixty-seven lumens per watt.
